(19) United States
(12) Patent Application Publication
(10) Pub. No.: US 2016/0153355 A1
(43) Pub. Date: Jun. 2, 2016

(54) Micro-cell using the process of electrolysis and air ionization with milli-amps of electricity and airflow to create a plasma that is drawn into the combustion chamber of an engine via a vacuum

(71) Applicants: Alfredo J. Suarez, Tampa, FL (US); William B. Wylie, Palm Harbor, FL (US)

(72) Inventors: Alfredo J. Suarez, Tampa, FL (US); William B. Wylie, Palm Harbor, FL (US)

(21) Appl. No.: 14/197,519

(22) Filed: Mar. 5, 2014

(51) Int. Cl. F02B 43/10; F02M 27/04; F02B 43/12

(52) U.S. Cl. CPC F02B 43/10; F02B 43/12; F02M 27/04; F02B 2043/106

(57) ABSTRACT

A micro-cell using the process of electrolysis and ionization with mill-amps and airflow to create an combustible gas that is drawn in to the combustion engine chamber via a vacuum is disclosed. By using mill-amps draw and less than one liter per minute of oxy-hydrogen gas the computer self-adjusts without rejecting the new air fuel mixtures.

### BACKGROUND OF THE INVENTION

### Problem Solved

The invention increases fuel efficiency in the engine combustion chamber while simultaneously reducing harmful emissions

Other devices in the marketplace use large amounts of energy from the alternator or battery of the engine and produce greater than one to two liters per minute of Oxy-hydrogen gas.

By using milli-amps draw and less than one liter per minute of oxy-hydrogen ga he computer self-adjusts without rejecting the new air fuel mixtures.

### DETAILED DESCRIPTION OF THE INVENTION

As stated above, The invention increases fuel efficiency in the engine combustion chamber while simultaneously reducing harmful emissions The invention claimed here solves this problem.

By introducing a micro-hydrogen gas and ionized air into the engine compartment via a vacuum it completes the burn of the already existing fuel source which in turn reduces harmful emissions such as hydrocarbons or carbon monoxide.

The claimed invention differs from what currently exists. The device is much smaller in design and using less initial energy as mill-amps while combining two types of air mixture that hasn't been combined in the past.

This invention is an improvement on what currently exists. The device is much smaller in design and using less initial energy as mill-amps while combining two types of air mixture that hasn't been combined in the past.

These devices draw too much energy from the stored energy source and the on-board computer controlled engine management systems reject the larger amounts of oxy-hydrogen as the computer adjusts for air fuel mixtures.

By using milli-amps draw and less than one liter per minute of oxy-hydrogen gas the computer self-adjusts without rejecting the new air fuel mixtures.

We claim:

1. A method of increasing the fuel efficiency in an engine combustion chamber comprising:
introducing micro-hydrogen gas into the engine compartment by ionizing air with a milli-amp current; and
drawing ionized air and micro-hydrogen gas into the said engine combustion chamber.

2. The method of claim 1, comprising drawing less than one liter per minute of oxy-hydrogen gas into the engine compartment.

3. A micro-cell using the process of electrolysis and ionization with milli-amps and airflow to create a combustible gas that is drawn into a combustion engine chamber via vacuum.
